(19) United States
(12) Patent Application Publication
(10) Pub. No.: US 2026/0278839 A1
(43) Pub. Date: Sep. 17, 2026

(54) Camera Calibration Using Feature of Vehicle

(71) Applicant: Supernal, LLC, Washington, DC (US)

(72) Inventor: Matthew Phillip Aralis, Washington, DC (US)

(73) Assignee: Supernal, LLC, Washington, DC (US)

(21) Appl. No.: 18/872,007

(22) PCT Filed: Jun. 9, 2023
(86) PCT No.: PCT/US2023/024942

§ 371 Date: Dec. 5, 2024

Related U.S. Application Data
(60) Provisional application No. 63/366,182, filed on Jun. 10, 2022.

(51) Int. Cl. G06T 7/80; G06T 7/73

(52) U.S. Cl. CPC G06T 7/80; G06T 7/74; G06T 2207/10032; G06T 2207/30252

(57) ABSTRACT

A method includes capturing a first image of a feature of a vehicle using a first camera that is attached to the vehicle. The first image indicates a first transform between the first camera and the feature. The method also includes capturing a second image of an environment of the vehicle using a second camera that is attached to the vehicle. The method also includes determining a pose of the vehicle within the environment using the second image, a second transform between the second camera and the feature, and environmental information. The method also includes performing an action based on the pose of the vehicle within the environment.

### CROSS-REFERENCE TO RELATED APPLICATIONS

This application claims priority to U.S. Provisional Patent Application No. 63/366,182, filed on Jun. 10, 2022, the entire contents of which are incorporated by reference herein.

### BACKGROUND

Cameras that are attached to vehicles can be used for navigation and/or collision avoidance. Such cameras are often attached to structures of a vehicle that are flexible. For example, a camera might be attached to a wing of an aerial vehicle that is configured to flex with respect to the fuselage. As a result, the position and orientation of the camera with respect to a body of the vehicle may change as the structure bends or flexes. Some computer vision techniques are based on an assumption that the camera is at a fixed position and fixed orientation with respect to the body of the vehicle. Therefore, the camera moving or rotating with respect to the body of the vehicle can result in computer vision techniques generating inaccurate position or orientation data for the vehicle. The present invention seeks to provide more accurate vehicle data by calibrating the cameras with respect to the vehicle.

### SUMMARY

A first example is a method comprising: capturing a first image of a feature of a vehicle using a first camera that is attached to the vehicle, the first image indicating a first transform between the first camera and the feature; capturing a second image of an environment of the vehicle using a second camera that is attached to the vehicle; determining a pose of the vehicle within the environment using the second image, a second transform between the second camera and the feature, and environmental information; and performing an action based on the pose of the vehicle within the environment.

A second example is a non-transitory computer readable medium storing instructions that, when executed by one or more processors of a vehicle, cause the vehicle to perform the method of the first example.

A third example is a vehicle comprising: a first camera; a second camera; one or more processors; and a computer readable medium storing instructions that, when executed by the one or more processors, cause the vehicle to perform the method of the first example.

When the term “substantially” or “about” is used herein, it is meant that the recited characteristic, parameter, or value need not be achieved exactly, but that deviations or variations, including, for example, tolerances, measurement error, measurement accuracy limitations, and other factors known to those of skill in the art may occur in amounts that do not preclude the effect the characteristic was intended to provide. In some examples disclosed herein, “substantially” or “about” means within +/−0-5% of the recited value.

The term “pose” is used herein to refer to position and/or orientation.

The present disclosure relates to systems, methods, and devices for calibrating a sensor or sensors.

In the present disclosure, certain aspects and embodiments will become evident. It is contemplated that the aspects and embodiments, in their broadest sense, could be practiced without having one or more features of these aspects and embodiments. It is also contemplated that these aspects and embodiments are merely exemplary.

According to some embodiments consistent with the disclosure herein, a calibration system can comprise a vehicle comprising a processor, a first sensor and a second sensor attachable to a rigid mount of the vehicle, and at least one calibration feature on the vehicle, wherein at least one aspect of the calibration feature is known, wherein the processor determines an image plan associated with the second sensor, wherein the image plan includes the known aspect of the calibration feature, wherein the processor compares sensory input from the second sensor of the known aspect to the image plan, wherein the processor determines a second calibration movement of the second sensor resulting from the comparison, wherein the processor transforms the second calibration movement to determine a first calibration movement of the first sensor, wherein the processor calibrates the first sensor based on the determined first calibration movement.

In some embodiments, the vehicle is a flying vehicle, such as an aircraft (including but not limited to fixed wing, rotor, vertical take-off and landing aircraft) or a drone. In some embodiments, the aspect can be disposed at a known distance away from the second sensor.

In some embodiments, the second sensor is an image sensor with a wide angle short focal length optical lens configured to capture the known calibration feature. In some embodiments, the first and second sensors are cameras. In some embodiments, the first sensor is forward facing. In some embodiments, the second sensor is rear facing.

According to some embodiments consistent with the disclosure herein, a vehicle can comprise a processor, a first sensor attached rigidly to the vehicle relative to a second sensor, and at least one calibration feature on the vehicle, wherein at least one aspect of the calibration feature is known, wherein the processor determines an image plan associated with the second sensor, wherein the image plan includes the known aspect of the calibration feature, wherein the processor compares sensory input from the second sensor of the known aspect to the image plan, wherein the processor determines a second calibration movement of the second sensor resulting from the comparison, wherein the processor transforms the second calibration movement to determine a first calibration movement of the first sensor, wherein the processor calibrates the first sensor based on the determined first calibration movement.

According to some embodiments of the disclosure, the at least one feature is disposed at a known distance away from the second sensor. According to some embodiments of the disclosure, the first sensor is forward facing. According to some embodiments of the disclosure, the second sensor is rear facing. According to some embodiments of the disclosure, the vehicle is a flying craft. According to some embodiments of the disclosure, the second sensor is an image sensor with a wide angle short focal length optical lens configured to capture the known calibration feature.

According to some embodiments consistent with the disclosure herein, a non-transitory computer readable medium for calibrating, the computer readable medium configured to, when executed by at least one processor, can cause the at least one processor to perform instructions comprising steps of sensing the known feature of the vehicle by a calibration sensor, determining a calibration movement based on the difference between a determined origin associated with the calibration sensor and at least one known calibration feature reference frame based on the known feature of the vehicle, determining a sensor transform between a position of the calibration sensor and a position of the primary sensor, transforming the calibration movement to a frame of reference of the primary sensor based on the sensor transform, and calibrating the primary sensor based on the transformed calibration movement.

In some embodiments, the primary sensor and the calibration sensor are cameras. In some embodiments, the first sensor is forward facing. In some embodiments, the second sensor is rear facing. In some embodiments, the first and second sensors are cameras. In some embodiments, the known calibration feature reference frame can be based on a feature descriptor.

Exemplary disclosed embodiments include devices, systems, methods, and a computer readable medium for calibrating a camera. For example, in some embodiments, a calibration system may include a processor. As used herein, processor may refer to a central processing unit or any other machine that processes something. Some non-limiting examples may include a microprocessor, a microcontroller, or an embedded processor.

Consistent with disclosed embodiments, while the figures illustrate the system disposed on a flying craft, it is contemplated that the system according to the present disclosure may be implemented, incorporated in, or utilized in conjunction with any type of vehicle, such as motor vehicle (e.g., motorcycles, cars, trucks, buses), railed vehicle (e.g., trains, trams), or watercraft. As used herein, flying craft may refer to an aerial, floating, soaring, hovering, airborne, aeronautical aircraft, airplane, plane, spacecraft, vessel or other vehicle moving or able to move through air. Some non-limiting examples may include a helicopter, an airship, a hot air balloon, an unmanned aerial vehicle, a vertical take-off craft, or a drone.

As discussed above, the system may be configured to include the body of a vehicle, such as the body of a flying craft. In one example, the calibration system may be configured to include a processor (e.g., a microprocessor) and the flying craft body (e.g., a helicopter).

Consistent with disclosed embodiments, the system may be configured with at least a first sensor and a second sensor attachable to a rigid mount of the vehicle. In some embodiments, a first sensor may be attached rigidly relative to the second sensor. The rigid attachment may include a pinned, bonded, welded, or bolted connection or the like to the vehicle body.

As used herein, attachable may refer to appendable, connective, separable, or otherwise capable of being fastened or added to something else. As used herein, a rigid mount or rigidly mounted may refer to an inflexible, unpliant, unbending, unyielding, or other support unable to bend or be forced out of shape. A rigid mount may include a bolted, welded, pinned, epoxied, or glued mount. Some non-limiting examples of a sensor may include a temperature sensor, a proximity sensor, an infrared sensor, a light sensor, an ultrasonic sensor, a position sensor, a force sensor, a vibration sensor, or an image sensor.

Some non-limiting examples of a rigid mount may include an industrial grade suction cup or adhesive, a tailor-made strut-style mount, or a permanent mounting point. For example, the system may be configured with at least a first sensor (e.g., an image sensor) and a second sensor (e.g., an image sensor) attachable to a rigid mount (e.g., an industrial grade suction cup) of the vehicle. As another example, the rigid mount may be configured to lock the first and/or second sensors into known positions, such as via one or more hard stops, gears, steps, or the like. As another example, the system may include one or more actuators configured to allow movement of first and/or second sensors and that use one or more hard stops, gears, steps, or the like to rigidly lock the first sensor and/or the second sensor into known positions and/or orientations.

The system may be configured with at least a first sensor and a second sensor attachable to a rigid mount of a vehicle's body. For example, the system may be configured with at least the first sensor (e.g., an image sensor) and the second sensor (e.g., an image sensor) attachable to the rigid mount (e.g., a rigid mounting point) of the vehicle's body.

In some embodiments, the second sensor may be an image sensor with a wide angle short focal length optical lens configured to capture the known calibration feature. In some embodiments, the first and second sensors may be cameras. As used herein, an image sensor may refer to a sensor that detects and conveys information used to make an image. As used herein, a wide angle short focal length optical lens may refer to a lens whose focal length may be substantially smaller than the focal length of a normal lens for a given film plane. As used herein, a calibration feature may refer to a reference object that consists of a defined shape pattern manufactured to a surface. Some non-limiting examples of a wide angle short focal length optical lens may be a lens of focal length 35 millimeters or less. Some non-limiting examples of a calibration feature may be a flying craft's tail number or other identifier painted or printed on the vehicle. For example, in some embodiments, the second sensor may include an image sensor (e.g., a camera) with a wide angle short focal length optical lens (e.g., a lens of focal length 35 millimeters or less) configured to capture the known calibration feature (e.g., a flying craft's tail number). Alternatively, in some embodiments, the first and second sensors may be cameras.

In some embodiments, the second sensor may include an image sensor with a wide angle short focal length optical lens configured to capture a known calibration feature. In some embodiments, a first sensor and the second sensor may be cameras. For example, in some embodiments, the second sensor may be an image sensor (e.g., a camera) with a wide angle short focal length optical lens (e.g., a lens of focal length 35 millimeters or less) configured to capture the known calibration feature (e.g., a flying craft's tail number) as shown by a sensor's sense.

Consistent with disclosed embodiments, the system may be configured with at least one calibration feature on the vehicle, wherein at least one aspect of the calibration feature is known. In some embodiments, the at least one feature is disposed at a geometric location a known distance away from the second sensor. As used herein, at least one feature may refer to an aspect, character, component, detail, element, or other distinctive attribute or aspect of something. As used herein, a geometric location may refer to a direction or position relative to a shape of an object. Some non-limiting examples of the at least one aspect may include the letter or letters, number or numbers, character or characters of a calibration feature (e.g., a tail number). Some non-limiting examples of the geometric location may be adjacent to a second sensor, next to a second sensor, parallel with the second sensor, or on a surface of the vehicle, such as on the tail or nose gear of a flying craft. For example, the system may be configured with the at least one calibration feature (e.g., the tail number) on a flying craft, wherein the at least one aspect (e.g., letter, letters, number, numbers, character, characters of the tail number) is known. For example, the at least one feature may be disposed at the geometric location a known distance away (e.g., a foot, five feet, ten feet and so forth) from the second sensor.

The system may be configured with at least one calibration feature on a vehicle's body, wherein at least one aspect of the at least one calibration feature is known. In some embodiments, the at least one aspect may be disposed at a geometric location a known distance away from the second sensor. For example, the system may be configured with the at least one calibration feature (e.g., a tail number) on a flying craft's body, wherein the at least one aspect (e.g., letters, numbers, characters) is known. For example, the at least one feature may be disposed at the geometric location a known distance away (e.g., a foot, five feet, ten feet) from the second sensor.

Consistent with disclosed embodiments, the processor may be configured for determining an image plan associated with the second sensor, wherein the image plan includes a known aspect of the calibration feature. As used herein, an image plan may refer to the area sensed by the second sensor. Some non-limiting examples may include an area of part of a vehicle's body and its surroundings or may include an area of the vehicle's surroundings and not part of the vehicle's body. Advantageously, some embodiments may be configured wherein the image plan includes a known aspect (e.g., characters, numbers, figures or letters of a tail number) of the calibration feature (e.g., the tail number). The known aspect may include feature descriptors which can be full or partial two-dimensional geometric shapes representing edges, lines, curves, triangles, circles, or similar. The known aspect may include feature descriptors which can be full or partial three-dimensional geometric shapes representing cubes, spheres, or planes. Feature descriptors may be determined by looking at changes in pixel gradients in the image. Feature descriptors can be a sum of pixel gradients that combine to form the known feature. For example, feature descriptors can be found on the corners of a known feature and along the edges of the known feature, where the known feature is a letter, and when each feature descriptor is combined, it indicates the known feature. For example, the known feature could be the letter “R,” and the feature descriptors can be the intersection of lines, the curve, the corners of the letter, and/or the edges between corners or intersections.

The processor may be configured for determining an image plan associated with a second sensor (e.g., a camera), wherein the image plan includes a known aspect of the at least one calibration feature. For example, the processor may be configured for determining the image plan associated with the second sensor that includes a part of the vehicle's body and its surroundings.

Consistent with disclosed embodiments, the processor may be configured for comparing sensory input from the second sensor of the known feature to the image plan. As used herein, compare may refer to analyze, contrast, measure, consider, or otherwise estimate the similarity or dissimilarity between. For example, a processor (e.g., a microprocessor) may be configured for comparing sensory input from the second sensor of the known feature (e.g., a calibration feature six feet away from the second sensor) to the image plan (e.g., the calibration feature five feet away from the second sensor). Alternatively, the processor may be configured for comparing sensory input from the second sensor of the known feature (e.g., the calibration feature not sensed by the second sensor) to the image plan (e.g., the calibration feature five feet away from the second sensor).

In some embodiments, the processor (e.g., a microprocessor) may be configured for comparing sensory input from a second sensor of the known feature (e.g., the at least one calibration feature that could be located six feet away from the second sensor) to an image plan (e.g., the at least one calibration feature that could be located five feet away from the second sensor).

Consistent with disclosed embodiments, the processor may be configured for determining a second calibration movement resulting from the comparison. As used herein, a calibration movement may refer to an adjustment, correction, fix, alignment, or other act of checking, by comparison with a standard, the accuracy of a measuring instrument. Some non-limiting examples of calibration movements may include rotation and/or translation. For example, a processor (e.g., a microprocessor) may be configured for determining the second calibration movement (e.g., a rotation of 0.1°, 0.5°, 1° and so forth) resulting from the comparison as discussed above.

In some embodiments of system 100, the processor may be configured for determining a second calibration movement resulting from the comparison. For example, a processor (e.g., a microprocessor) may be configured for determining the second calibration movement (e.g., a rotation of 1°) resulting from the comparison as discussed above.

Consistent with disclosed embodiments, the processor may be configured for transforming second calibration movement of the second sensor to determine the first calibration movement of the first sensor. As used herein, a first transform may refer to a first or primary process that manipulates or changes a polygon or other two-dimensional or three-dimensional object on a vehicle or vehicles or coordinate system or systems. Some non-limiting examples of transformations may include a dilation, reflection, rotation, shear, or translation. For example, the processor (e.g., a microprocessor) may be configured for transforming (e.g., a rotation or rotations) second calibration movement of the second sensor (e.g., a camera) to determine the first calibration movement of the first sensor (e.g., a camera).

In some embodiments, the processor of system may be configured for transforming second calibration movement of a second sensor to determine a first calibration movement of a first sensor. For example, the processor of system may be configured for transforming second calibration movement (e.g., a rotation of 1°) of the second sensor (e.g., a camera) to determine the first calibration movement (e.g., a rotation of 2°) of the first sensor (e.g., a camera). In some cases, the first calibration movement may be determined by knowing the placement and orientation of the first sensor relative to the second sensor because of the rigid attachment. In some cases, the calibration movement may be determined by using hard stops, gears, steps, or the like between the first sensor relative to the second sensor.

Consistent with disclosed embodiments, the processor may be configured for calibrating the first sensor based on the determined first calibration movement. For example, a processor (e.g., a microprocessor) may be configured for calibrating (e.g., a rotation or rotations) the first sensor (e.g., a camera) based on the determined first calibration movement (e.g., a rotation of 0.1°, 0.5°, 1° and so forth).

In some embodiments, the processor of system may be configured for calibrating a first sensor based on a determined first calibration movement.

According to another embodiment of the present disclosure, a non-transitory computer readable medium comprising instructions to perform steps may be provided. The steps may be configured for determining a calibration movement based on the difference between a determined origin associated with a calibration sensor and at least one known calibration feature reference frame. As used herein, reference frame may refer to a system of geometric axes in relation to which measurements of size, position, or motion can be made. As used herein, non-transitory computer readable medium refers to any type of physical memory on which information or data readable by at least one processor can be stored. Some non-limiting examples may include Random Access Memory, Read-Only Memory, hard drives, floppy disks, or any other optical data storage medium and so forth. As used herein, a determined origin may refer to a point or place where something begins, arises, or is derived by definition or established in advance. Some non-limiting examples of the determined origin may refer to the two or three-dimensional location in space. As used herein, a calibration sensor may refer to a sensor or measuring system that determines under defined conditions the relationship between the values of a measurand output with corresponding measurement uncertainty and the corresponding values of a measurand established with standards with corresponding measurement uncertainty. For example, the steps may be configured for determining the calibration movement (e.g., a rotation) based on the difference between the determined origin associated with the calibration sensor (e.g., a second sensor) and at least one known calibration feature reference frame (e.g., a tail number).

The steps may be configured for determining a calibration movement (e.g., a rotation or translation) based on the difference between a determined origin associated with a calibration sensor (e.g., a second sensor) and the at least one known calibration feature (e.g., a tail number of an aircraft) reference frame.

Consistent with disclosed embodiments, the steps may also be configured for determining a sensor transform between a position of the calibration sensor and a position of the primary sensor. As used herein, a transform may refer to a first or primary process that manipulates or changes a polygon or other two-dimensional or three-dimensional object on a plane or planes or coordinate system or systems. Some non-limiting examples of transformations may include a dilation, reflection, rotation, shear, or translation. In some embodiments, the primary and calibration sensors may be cameras. As discussed herein, the primary sensor may refer to a first sensor. For example, the steps may be configured for determining the sensor transform (e.g., a rotation) between the position of the calibration sensor (e.g., a second sensor) and the position of the primary sensor (e.g., a first sensor). In some embodiments, the primary and calibration sensors may be cameras.

In some embodiments, the steps may be configured for determining a sensor transform (e.g., a rotation or translation) between a position of a calibration sensor (e.g., a second sensor) and a position of a primary sensor (e.g., a first sensor). In some embodiments, the primary and calibration sensors may be cameras.

Consistent with disclosed embodiments, the steps may also be configured for transforming the calibration movement to a frame of reference of the primary sensor based on the sensor transform. For example, the steps may be configured for transforming (e.g., rotating or translating) a calibration movement to the frame of reference of the primary sensor (e.g., a first sensor) based on the sensor transform.

In some embodiments, the steps may be configured for transforming (e.g., rotating or translating) a calibration movement to a frame of reference of a primary sensor (e.g., a first sensor) based on a sensor transform.

Consistent with disclosed embodiments, the steps may also be configured for calibrating the primary sensor based on the transformed calibration movement. Some non-limiting examples of calibrating a primary sensor may include rotation and/or translation of the primary sensor. For example, the steps may be configured for calibrating (e.g., a rotation of 5°) the primary sensor (e.g., a first sensor) based on the determined calibration movement.

In some embodiments, the steps may be configured for calibrating (e.g., a rotation of 5°) a primary sensor (e.g., a first sensor) based on the determined calibration movement.

The foregoing descriptions of specific embodiments of the present disclosure are presented for purposes of illustration and description. While illustrative embodiments have been described herein, the scope of the present disclosure includes any and all embodiments having equivalent elements, modifications, omissions, combinations (e.g., of aspects across various embodiments), adaptations and/or alterations as would be appreciated by those skilled in the art based on the present disclosure. For example, it will be apparent to those skilled in the art that various modifications and variations can be made to the disclosed flying craft and/or the disclosed processes for calibrating sensor(s) and/or processor(s). The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the present disclosure. It is intended, therefore, that the specification and examples be considered as exemplary only, with a true scope and spirit of the present disclosure being indicated by the following claims and their full scope of equivalents These, as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate the invention by way of example only and, as such, that numerous variations are possible.

### BRIEF DESCRIPTION OF THE DRAWINGS

FIG. 1 is a block diagram of a vehicle, according to an exemplary embodiment of the present invention.

FIG. 2 is a schematic diagram of structures and functionality of a vehicle that operates within an environment, according to an exemplary embodiment of the present invention.

FIG. 3 is a block diagram of a method, according to an exemplary embodiment of the present invention.

### DETAILED DESCRIPTION

As noted above, more reliable methods of using cameras to determine a pose of a vehicle within its environment are needed. Accordingly, a method includes capturing a first image of a feature of a vehicle using a first camera that is attached to the vehicle. The feature could be a fiducial marker on the body (e.g., fuselage) of the vehicle. The first image indicates a first transform between the first camera and the feature. That is, the first image can be used to determine a difference or a transform between the pose of the first camera and the pose of the feature. The method also includes capturing a second image of an environment of the vehicle using a second camera that is attached to the vehicle. Whereas the first camera could be rear-facing and have a field of view that includes the feature of the aircraft, the second camera could be forward-facing and have a field of view that does not include any portion of the aircraft. Thus, the environment depicted by the second image could include buildings, trees, birds, other vehicles, etc. The method also includes determining a pose of the vehicle within the environment using the second image, a second transform between the second camera and the feature, and environmental information. The first camera and the second camera generally have poses that are fixed relative to each other. Therefore, a computing device can obtain the pose of the second camera using the pose of the first camera. The computing device can obtain the pose of the first camera using the first image of the feature, intrinsic characteristics of the first camera, and structural information associated with the vehicle and/or the feature. The computing device uses the pose of the second camera obtained using the pose of the first camera to map the environment shown in the second image to the reference frame of the feature (i.e., the reference frame of the aircraft). The method also includes performing an action based on the pose of the vehicle within the environment, such as controlling the vehicle to avoid objects or move toward objects detected within the environment.

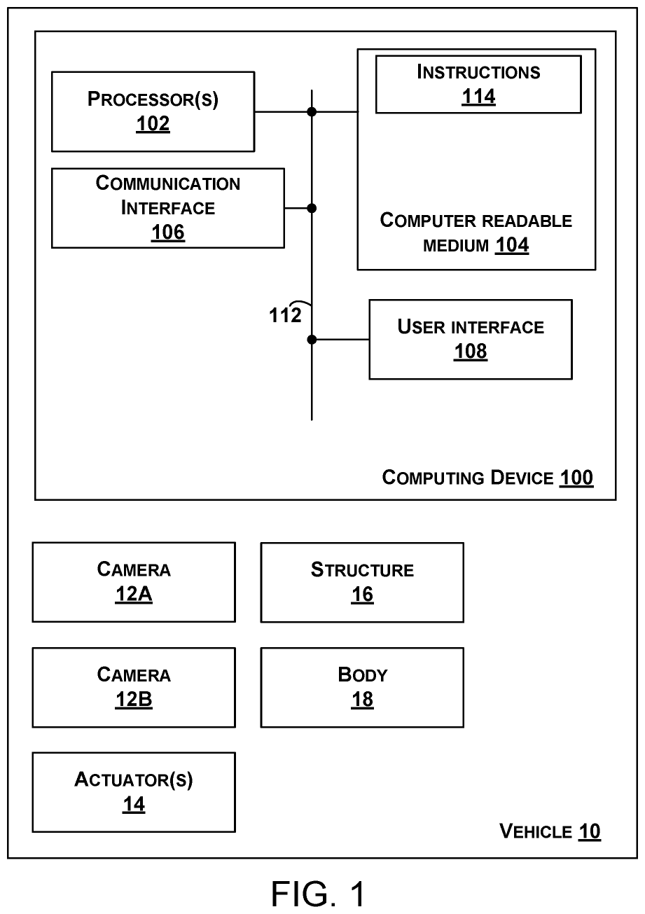

FIG. 1 is a block diagram of a vehicle 10. The vehicle 10 may include a computing device 100, a camera 12A, a camera 12B, acuator(s) 14, a structure 16, and a body 18.

The computing device 100 may include one or more processors 102, a non-transitory computer readable medium 104, a communication interface 106, and a user interface 108. Components of the computing device 100 may be linked together by a system bus, network, or other connection mechanism 112.

The one or more processors 102 can be any type of processor(s), such as a microprocessor, a field programmable gate array, a digital signal processor, a multicore processor, etc., coupled to the non-transitory computer readable medium 104.

The non-transitory computer readable medium 104 can be any type of memory, such as volatile memory like random access memory (RAM), dynamic random access memory (DRAM), static random access memory (SRAM), or non-volatile memory like read-only memory (ROM), flash memory, magnetic or optical disks, or compact-disc read-only memory (CD-ROM), among other devices used to store data or programs on a temporary or permanent basis.

Additionally, the non-transitory computer readable medium 104 can store instructions 114. The instructions 114 are executable by the one or more processors 102 to cause the computing device 100 to perform any of the functions or methods described herein.

The communication interface 106 can include hardware to enable communication within the computing device 100 and/or between the computing device 100 and one or more other devices. The hardware can include any type of input and/or output interfaces, a universal serial bus (USB), PCI Express, transmitters, receivers, and antennas, for example. The communication interface 106 can be configured to facilitate communication with one or more other devices, in accordance with one or more wired or wireless communication protocols. For example, the communication interface 106 can be configured to facilitate wireless data communication for the computing device 100 according to one or more wireless communication standards, such as one or more Institute of Electrical and Electronics Engineers (IEEE) 801.11 standards, ZigBee standards, Bluetooth standards, etc. As another example, the communication interface 106 can be configured to facilitate wired data communication with one or more other devices. The communication interface 106 can also include analog-to-digital converters (ADCs) or digital-to-analog converters (DACs) that the computing device 100 can use to control various components of the computing device 100 or external devices.

The user interface 108 can include any type of display component configured to display data. As one example, the user interface 108 can include a touchscreen display. As another example, the user interface 108 can include a flat-panel display, such as a liquid-crystal display (LCD) or a light-emitting diode (LED) display. The user interface 108 can include one or more pieces of hardware used to provide data and control signals to the computing device 100. For instance, the user interface 108 can include a mouse or a pointing device, a keyboard or a keypad, a microphone, a touchpad, or a touchscreen, among other possible types of user input devices. Generally, the user interface 108 can enable an operator to interact with a graphical user interface (GUI) provided by the computing device 100 (e.g., displayed by the user interface 108).

The camera 12A and the camera 12B may generally take the form of visible light cameras with digital image sensors. However, the camera 12A and the camera 12B could take other forms such as a thermal imaging camera or any other device that detects light and generates an image (e.g., an array of pixel values) that characterizes the light.

The actuators(s) 14 can include engines, motors, propellers, rotors, jet engines, and/or control surfaces, for example.

The structure 16 typically takes the form of a wing of the vehicle 10, but could take the form of any flexible structure that extends away from the body 18.

The body 18 could be a fuselage or an empennage, or any other structure of the vehicle 10.

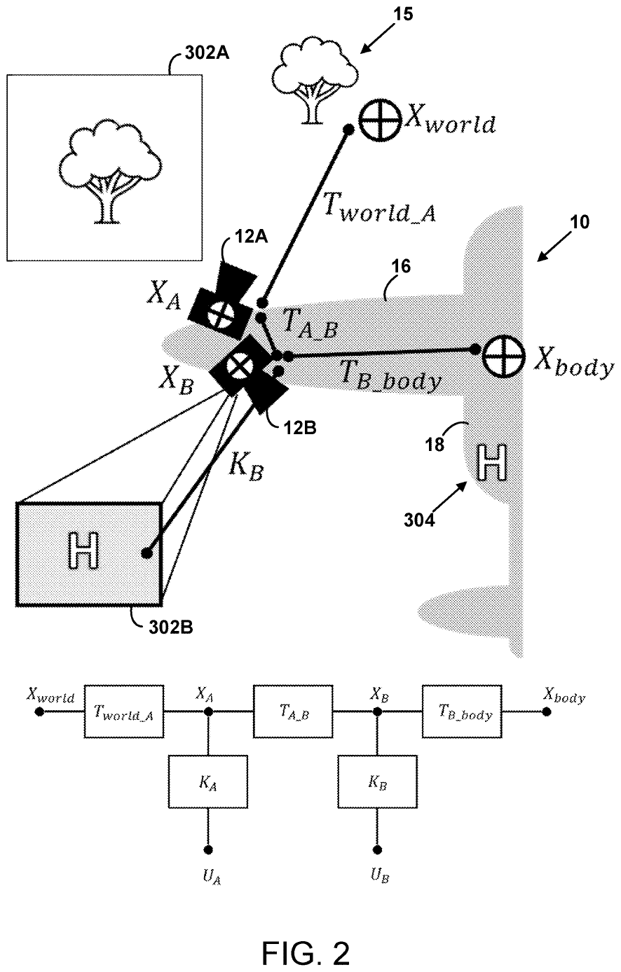

FIG. 2 is a schematic diagram of structures and functionality of the vehicle 10 that operates within an environment 15. In FIG. 2, the vehicle 10 takes the form of an aerial vehicle. As shown, the vehicle is a winged vehicle but the vehicle 10 could also be a helicopter or a quadcopter. Other examples are possible.

The camera 12A and the camera 12B are attached to the structure 16 which takes the form of a wing that is configured to flex with respect to the body 18. The camera 12A and the camera 12B are fixed relative to each other on the structure 16 such that the camera 12A cannot translate or rotate with respect to the camera 12B. For example, the camera 12A and the camera 12B could be contained and fixed within a common housing that is attached to the structure 16.

The structure 16 is configured to flex or bend with respect to the body 18. The structure 16 takes the form of a wing, for example. The feature 304 is located on the body 18 which takes the form of a fuselage. In FIG. 2, the feature 304 is the letter “H,” however the feature 304 could take any form that is recognizable using computer vision techniques.

In operation, the camera 12B captures an image 302B of the feature 304. The image 302B implicitly indicates a transform T_{B_body} between the camera 12B and the feature 304 as discussed in more detail below. The camera 12A also captures an image 302A of the environment 15. In some examples, the camera 12A captures the image 302A simultaneously with the camera 12B capturing the image 302B. However, the assumption that the image 302A and the image 302B were captured by cameras separated by the known and fixed transform T_{A_B} will remain reasonable if the capture time between the image 302A and the image 302B is reasonable.

Next, the computing device 100 determines the pose (e.g., the position and/or orientation) of the vehicle 10 within the environment 15 using the image 302A, a transform T_{A_body} between the camera 12A and the feature 304, and environmental information such as global positioning system (GPS) data or survey data defining the environment 15. The computing device 100 obtains the transform T_{A_body} by compounding the known transform T_{A_B} with the transform T_{B_body}, as described below. Thereafter, the vehicle 10 performs an action based on the pose of the vehicle 10 within the environment 15.

The computing device 100 determines the transform T_{B_body} using the image 302B, intrinsic characteristics K_{B} of the camera 12B, and structural information associated with the vehicle 10 and/or the feature 304. The image 302B is useful for determining the transform T_{B_body} because the image 302B is captured by the camera 12B which has the transform T_{B_body} with respect to the feature 304. The intrinsic characteristics K_{B} of the camera 12B used to determine the transform T_{B_body} include a focal length of the camera 12B, an optical center of the camera 12B, and/or a skew coefficient of the camera 12B. The computing device 100 uses the intrinsic characteristics K_{B} to transform the image 302B into a three-dimensional point cloud within the reference frame X_{B} associated with the camera 12B. The computing device 100 uses (a) the structural information associated with the vehicle 10 and/or the feature 304 and (b) the three-dimensional point cloud of the image 302B within the reference frame X_{B} to solve for the transform T_{B_body}. The structural information associated with the vehicle 10 can include (i) a reference transform between the feature 304 and the camera 12B and (ii) a feature descriptor associated with the feature 304.

The feature descriptor can include a reference image captured by the camera 12B while having the reference transform with respect to the feature 304. Alternatively, the feature descriptor can include a compressed image of the feature 304. The computing device 100 can determine the transform T_{B_body} using direct linear transformation, Zhang's method, or Tsai's method. The computing device 100 can then use the transform T_{B_body} and the transform T_{A_B} to determine the transform T_{A_body}.

In some examples, the computing device 100 processes the image 302A using intrinsic characteristics K_{A} of the camera 12A to generate a three-dimensional point cloud within a reference frame X_{A} of the camera 12A. The computing device 100 processes the three-dimensional point cloud of the image 302A within the reference frame X_{A} using the transform T_{A_body} such that the three-dimensional point cloud representing the image 302A is represented within the reference frame X_{body} of the feature 304. The computing device 100 also processes the environmental information such that the environmental information is within the reference frame X_{body}. In this context, the computing device 100 determines the pose of the aircraft 10 within the environment 15 using the three-dimensional point cloud of the image 302A within the reference frame X_{body} and the environmental information within the reference frame X_{body}.

Once the computing device 100 determines the pose of the vehicle 10 within the environment, the computing device 100 can perform various actions. For example, the computing device 100 can process the image 302A using computer vision techniques to identify a position of an object within the environment 15 and control the vehicle 10 to move away from the position of the object or move toward the position of the object.

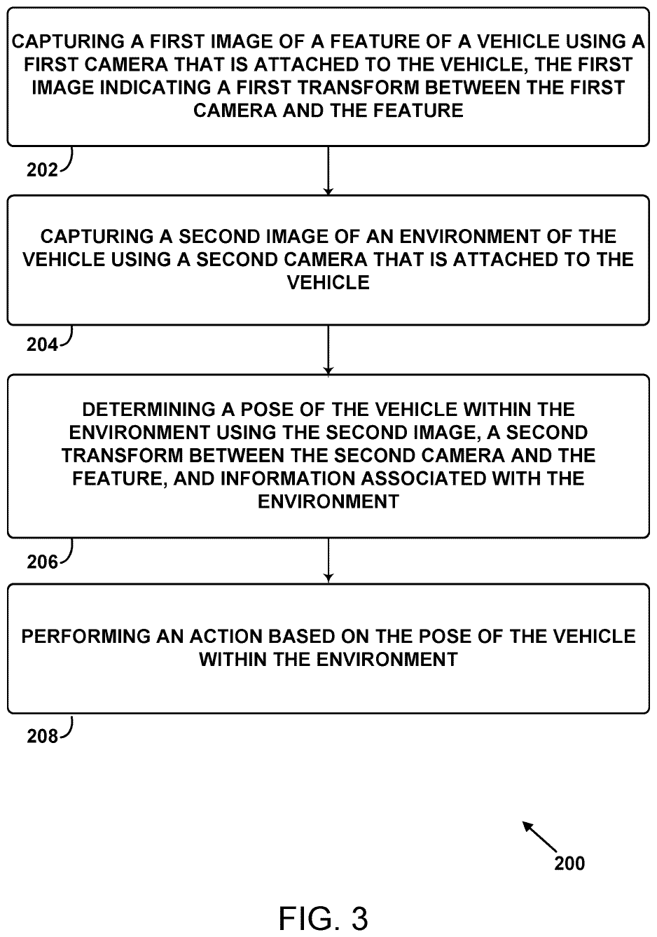

FIG. 3 is a block diagram of a method 200, which in some examples is performed by the vehicle 10. As shown in FIG. 3, the method 200 includes one or more operations, functions, or actions as illustrated by blocks 202, 204, 206, and 208. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 202, the method 200 includes capturing the image 302B of the feature 304 of the vehicle 10 using the camera 12B that is attached to the vehicle 10. The image 302B indicates the transform T_{B_body} between the camera 12B and the feature 304. Functionality related to block 202 is described above with reference to FIG. 2.

At block 204, the method 200 includes capturing the image 302A of the environment 15 of the vehicle 10 using the camera 12A that is attached to the vehicle 10. Functionality related to block 204 is described above with reference to FIG. 2.

At block 206, the method 200 includes determining the pose of the vehicle 10 within the environment 15 using the image 302A, the transform T_{A_body} between the camera 12A and the feature 304, and the environmental information. Functionality related to block 206 is described above with reference to FIG. 2.

At block 208, the method 200 includes performing the action based on the pose of the vehicle 10 within the environment 15. Functionality related to block 208 is described above with reference to FIG. 2.

### EXAMPLE EMBODIMENTS

1. A system comprising:
a vehicle comprising a processor;
a first sensor and a second sensor attachable to a rigid mount of the vehicle; and
at least one calibration feature on the vehicle, wherein at least one aspect of the calibration feature is known;
wherein the processor determines an image plan associated with the second sensor, wherein the image plan includes the known aspect of the calibration feature;
wherein the processor compares sensory input from the second sensor of the known aspect to the image plan;
wherein the processor determines a second calibration movement of the second sensor resulting from the comparison;
wherein the processor transforms the second calibration movement to determine a first calibration movement of the first sensor;
wherein the processor calibrates the first sensor based on the determined first calibration movement.

2. The system of example 1, wherein the vehicle is an aircraft.

3. The system of example 1, wherein the aircraft is a vertical take-off vehicle.

4. The system of example 1, wherein the vehicle is a motor vehicle.

5. The system of example 1, wherein the vehicle is a rail vehicle.

6 The system of example 1, wherein the at least one aspect is disposed at a known distance away from the second sensor.

7. The system of example 1, wherein the second sensor is an image sensor with a wide angle short focal length optical lens configured to capture the known calibration feature.

8. The system of example 1, wherein the first and second sensors are cameras.

9. The system of example 1, wherein the first sensor is forward facing.

10. The system of example 1, wherein the second sensor is rear facing.

11. A system comprising:
a vehicle comprising a processor;
a first sensor attached rigidly to the vehicle relative to a second sensor; and
at least one calibration feature on the flying craft, wherein at least one aspect of the calibration feature is known;
wherein the processor determines an image plan associated with the second sensor, wherein the image plan includes the known aspect of the calibration feature;
wherein the processor compares sensory input from the second sensor of the known aspect to the image plan;
wherein the processor determines a second calibration movement of the second sensor resulting from the comparison;
wherein the processor transforms the second calibration movement to determine a first calibration movement of the first sensor;
wherein the processor calibrates the first sensor based on the determined first calibration movement.

12. The calibration system of example 11, wherein the at least one aspect is disposed at a known distance away from the second sensor.

13. The calibration system of example 11, wherein the first sensor is forward facing.

14. The calibration system of example 11, wherein the second sensor is rear facing.

15. The calibration system of example 11, wherein the flying craft is a vertical take-off vehicle.

16. The calibration system of example 11, wherein the second sensor is an image sensor with a wide angle short focal length optical lens configured to capture the known calibration feature.

17. A non-transitory computer readable medium for calibrating, the computer readable medium configured to, when executed by at least one processor, cause the at least one processor to perform instructions comprising steps of:
sensing the known aspect of the vehicle by a calibration sensor;
determining a calibration movement based on the difference between a determined origin associated with the calibration sensor and at least one known calibration feature reference frame based on the known aspect of the vehicle;
determining a sensor transform between a position of the calibration sensor and a position of the primary sensor;
transforming the calibration movement to a frame of reference of the primary sensor based on the sensor transform; and
calibrating the primary sensor based on the transformed calibration movement.

18. The non-transitory computer readable medium of example 17, wherein the primary sensor and the calibration sensor are cameras.

19. The non-transitory computer readable medium of example 17, wherein the first sensor is forward facing.

20. The non-transitory computer readable medium of example 17, wherein the second sensor is rear facing.

21. The non-transitory computer readable medium of example 17, wherein the second sensor is an image sensor with a wide angle short focal length optical lens configured to capture the known aspect.

22. The non-transitory computer readable medium of example 17, wherein the known aspect is disposed at a known distance away from the second sensor.

23. The non-transitory computer readable medium of example 17, wherein the known calibration feature reference frame is based on a feature descriptor.

24. The non-transitory computer readable medium of example 17, wherein the vehicle is a vertical take-off vehicle.

While various example aspects and example embodiments have been disclosed herein, other aspects and embodiments will be apparent to those skilled in the art. The various example aspects and example embodiments disclosed herein are for purposes of illustration and are not intended to be limiting, with the true scope and spirit being indicated by the following claims.

1. A method comprising:
capturing a first image of a feature of a vehicle using a first camera that is attached to the vehicle, the first image indicating a first transform between the first camera and the feature;
capturing a second image of an environment of the vehicle using a second camera that is attached to the vehicle;
determining a pose of the vehicle within the environment using the second image, a second transform between the second camera and the feature, and environmental information; and
performing an action based on the pose of the vehicle within the environment.

2. The method of claim 1, wherein the vehicle comprises an aerial vehicle and the first camera and the second camera are attached to a structure that is configured to bend with respect to a fuselage of the aerial vehicle.

3. The method of claim 2, wherein the structure is a wing.

4. The method of claim 1, wherein determining the pose comprises determining a position and an orientation of the vehicle.

5. (canceled)

6. The method of claim 1, wherein the feature is located on a fuselage or an empennage of the vehicle.

7. The method of claim 1, wherein the first camera is fixed relative to the second camera.

8. (canceled)

9. The method of claim 1, wherein capturing the second image comprises capturing the second image simultaneously with capturing the first image.

10. The method of claim 1, further comprising determining the first transform using the first image, intrinsic characteristics of the first camera, and structural information associated with the vehicle and/or the feature.

11. The method of claim 10, wherein determining the first transform using the intrinsic characteristics of the first camera comprises determining the first transform using a focal length of the first camera, an optical center of the first camera, and/or a skew coefficient of the first camera.

12. The method of claim 10, wherein the structural information comprises (i) a reference transform between the feature and the first camera and (ii) a feature descriptor associated with the feature.

13. The method of claim 12, wherein the feature descriptor comprises a reference image captured by the first camera while having the reference transform with respect to the feature.

14. The method of claim 12, wherein the feature descriptor comprises a compressed image of the feature.

15. The method of claim 1, further comprising determining the first transform using direct linear transformation.

16. (canceled)

17. (canceled)

18. The method of claim 1, further comprising determining the second transform using a third transform between the feature and the first camera and a fourth transform between the first camera and the second camera.

19. The method of claim 1, further comprising:
processing the second image using intrinsic characteristics of the second camera to generate a three-dimensional point cloud within a first reference frame of the second camera;
processing the three-dimensional point cloud using the second transform such that the three-dimensional point cloud is within a second reference frame of the feature of the vehicle; and
processing the environmental information such that the environmental information is within the second reference frame,
wherein determining the pose comprises determining the pose using the three-dimensional point cloud within the second reference frame and the environmental information within the second reference frame.

20. The method of claim 1, wherein performing the action comprises:
identifying a position of an object within the environment; and
controlling the vehicle to move away from the position of the object.

21. The method of claim 1, wherein performing the action comprises:
identifying a position of an object within the environment; and
controlling the vehicle to move toward the position of the object.

22. The method of claim 1, wherein the environmental information includes global positioning system (GPS) signals received by the vehicle or survey data defining the environment.

23. (canceled)

24. (canceled)

25. A non-transitory computer readable medium storing instructions that, when executed by one or more processors of a vehicle, cause the vehicle to perform functions comprising:
capturing a first image of a feature of the vehicle using a first camera that is attached to the vehicle, the first image indicating a first transform between the first camera and the feature;
capturing a second image of an environment of the vehicle using a second camera that is attached to the vehicle;
determining a pose of the vehicle within the environment using the second image, a second transform between the second camera and the feature, and environmental information; and
performing an action based on the pose of the vehicle within the environment.

26. A vehicle comprising:
a first camera;
a second camera;
one or more processors; and
a computer readable medium storing instructions that, when executed by the one or more processors, cause the vehicle to perform functions comprising:
capturing a first image of a feature of the vehicle using a first camera that is attached to the vehicle, the first image indicating a first transform between the first camera and the feature;
capturing a second image of an environment of the vehicle using a second camera that is attached to the vehicle;
determining a pose of the vehicle within the environment using the second image, a second transform between the second camera and the feature, and environmental information; and
performing an action based on the pose of the vehicle within the environment.
